(19) United States
(12) Patent Application Publication
(10) Pub. No.: US 2007/0121973 A1
(43) Pub. Date: May 31, 2007

(54) Water-resistant case for handheld electronic device

(76) Inventor: Chun Chee Tsang, Kwai Fong (HK)

Correspondence Address: BOHAN, MATHERS & ASSOCIATES, LLC, PO BOX 17707, PORTLAND, ME, 04112-8707, US

(21) Appl. No.: 11/287,107

(22) Filed: Nov. 23, 2005

(51) Int. Cl. H04R 25/00

(52) U.S. Cl. 381/189

(57) ABSTRACT

Protective case for an electronic device. The device is inserted into an inner case, and the earphone-jack converter plugged into the earphone jack receptacle in the bottom of the device. Both the inner case, with electronic device, and the earphone-jack converter are inserted into an outer shell through a large opening in the back of the shell. The earphone jack is threaded through an earphone jack aperture in the outer shell and plugged into the earphone-jack converter. An outer back panel attaches to the back of the inner case, thereby forming a water-tight seal between the outer shell and the inner case. The inner case has cutouts on its front face, to provide access to the operational controls on the electronic device. The material of the outer shell is soft and flexible, and allows the user to operate the electronic device while it is encased in the protective case.

### BACKGROUND INFORMATION

1. Field of the Invention

The invention relates to the field of cases. More particularly, the invention relates to a case that protects the contents of the case from water and allows operation of a device encased therewithin.

2. Description of the Prior Art

Small, handheld electronic devices, such as audio devices and personal digital assistants (PDAs) are ubiquitous today in the general population. Users carry such devices with them throughout the day, for sometimes hours at a time. The devices are, thus, often subjected to inclement weather, such as rain, snow, or hail, or other harsh environments. For this reason, users often carry the device in a protective case.

Many cases for such small, handheld devices are known. The disadvantages of many of the cases are that they are not water-resistant, and this is the situation particularly with cases that are intended to hold audio devices, such as the ipod® or NANO IPOD®.

What is needed, therefore, is a case that securely holds a small, handheld electronic device, particularly an audio device, and that protects the device from the environment. What is further needed is such a case that provides a water-resistant barrier, yet allows the user to operate the device while it is enclosed within the case.

### BRIEF SUMMARY OF THE INVENTION

The invention is a case that is adapted to encase an electronic device and, more particularly, an audio device, and further provides a water-resistant enclosure for the device. The case comprises an inner case, an outer shell with an open back, an outer back panel, and an audio earphone jack converter that attaches to the inner case.

The inner case is a rigid case that is formed to securely hold the electronic device in place and that protects the device against impact shock. It has openings in the face panel that allow the device to be used while contained within the case. The outer shell is a flexible cover of a water-resistant material that is soft enough to enable operation of the electronic device encased within. The outer shell is open at the back. The entire inner case, with the device contained within it, is insertable into the outer shell at the open back. The edges of the flexible outer shell fold in over the back panel of the inner case. The outer back panel is then placed over the back of the outer shell and fastened to the back face of the inner case. For this purpose, the back face of the inner case is provided with an attachment means that mates with an attachment means that is either on or passes through the outer back panel. A threaded fastener, for example, is provided on the outer back panel that threads into a female threaded aperture on the back face of the inner case. Securely fastening the outer back panel up against the back face of the inner case draws the outer back panel close to the inner case, thereby causing it to firmly press against the edges of the outer shell that are folded over the back face of the inner case. This provides an effective water-tight seal. The front face of the outer shell is of a soft, flexible material, that allows the user to operate the controls of the device.

With audio devices, it is necessary to connect an earphone jack to the device. This connection must also be protected against water. In order to provide a water-tight seal for the earphone jack, an earphone jack converter is provided, that plugs into the earphone jack receptacle conventionally provided in the bottom face of the audio device. The converter allows the earphone jack to plug into the case from the side and in a horizontal orientation, rather than from the bottom, in a vertical orientation. The converter itself contains circuity that completes an electrical connection between a connector pin from the earphone jack of the audio device and the a connector pin provided in the converter, for plugging into the audio device. The converter, when connected to the audio device, is also inserted into the outer shell, along with the inner case.

The user of the audio device first inserts the device to be protected into the inner case and then attaches the earphone converter to the pin receptacle at the bottom of the device. The inner case, along with the device and the earphone-jack converter are then inserted into the outer shell. The earphone jack is inserted through the earphone jack aperture in the outer shell and plugged into the earphone-jack converter. The user then folds the material of the outer shell over the back face of the inner case and attaches the outer back panel to the back face of the inner case. The device may now be operated by the user by pushing the buttons on the control panel.

The materials used for the cases and the converter are not per se critical. A hard, rigid material, such as aluminum or other attractive metal, or a rigid pastic, may be used for the inner case. Silicon is a very suitable material for the outer shell, because it is waterproof and flexible. Other suitable materials include rubber or synthetic rubber. The outer back panel may be made of a metal, such as aluminum, or a hard plastic. Whatever material is used for the outer back panel, it must be sufficiently rigid to pull up against the inner case with sufficient strength and rigidity to hold the material of the outer shell tightly between the outer back panel and the inner case, yet not shatter or break under the pressure applied at the attachment means.

### BRIEF DESCRIPTION OF THE DRAWINGS

The present invention is described with reference to the accompanying drawings. In the drawings, like reference numbers indicate identical or functionally similar elements.

FIG. 1 is an illustration of the case according to the invention, showing an outer shell over an inner case and an earphone converter.

FIG. 2 is an illustration of the outer shell, seen from the back, showing the open back of the outer shell.

FIG. 3 is an illustration of the inner case.

FIG. 4 is an illustration of the earphone converter, showing a conventional earphone jack plugged into it.

FIG. 5 is an fronatl view of the inner case, with the earphone converter and a conventional earphone jack attached.

FIG. 6 is an exploded illustration of the case according to the invention, showing the outer back panel ready for attachment to the back face of the inner case, with the inner case enclosed within the outer shell.

FIG. 7 shows a soft plastic stopper that encircles the earphone jack and prevents the ingress of water into the case.

### DETAILED DESCRIPTION OF THE INVENTION

The present invention will now be described more fully in detail with reference to the accompanying drawings, in which the preferred embodiments of the invention are shown. This invention should not, however, be construed as limited to the embodiments set forth herein; rather, they are provided so that this disclosure will be complete and will fully convey the scope of the invention to those skilled in the art.

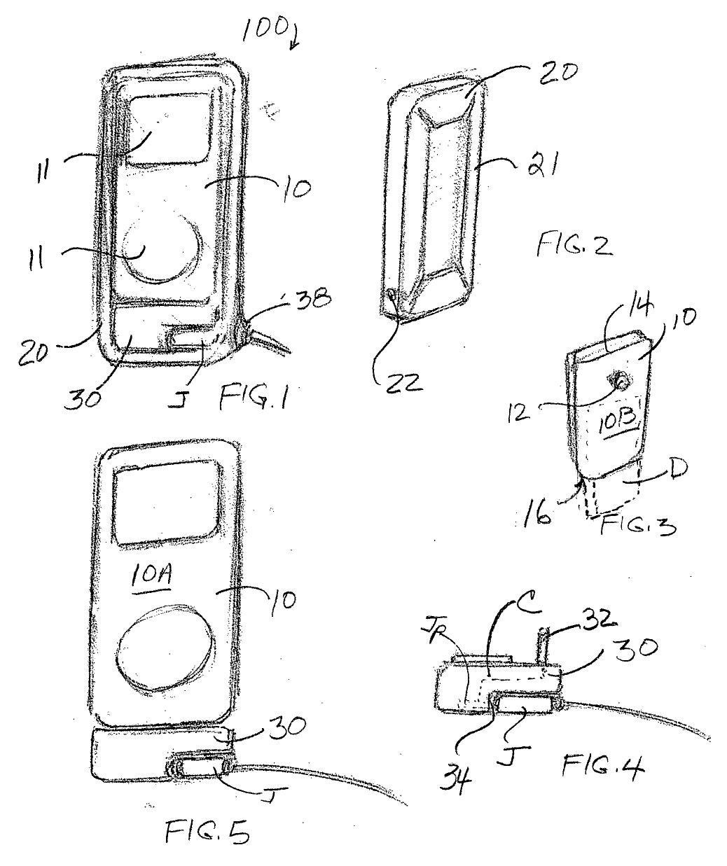

FIG. 1 is a perspective view of a protective case 100 according to the invention and FIGS. 2-7 illustrate various features of the case 100. The case 100 comprises an outer shell 20, an inner case 10, an earphone-jack converter 30, and a back panel 40 (shown in FIG. 6), and is intended to contain and protect a device D. The inner case 10 is a rigid container constructed to protect the device D from crushing and impact shock. The inner case 10 has a front face 10A with cutouts or apertures 11, a back face 10B, an upper closed face 14, and a lower open face 16, through which the device D is inserted. The apertures 11 allow the user to operate the device D while it is contained within the inner case 20. FIG. 3 shows with dashed lines the device D being inserted into the inner case 10. The back face 10B has an attachment means 12 to which the back panel 40 is attached.

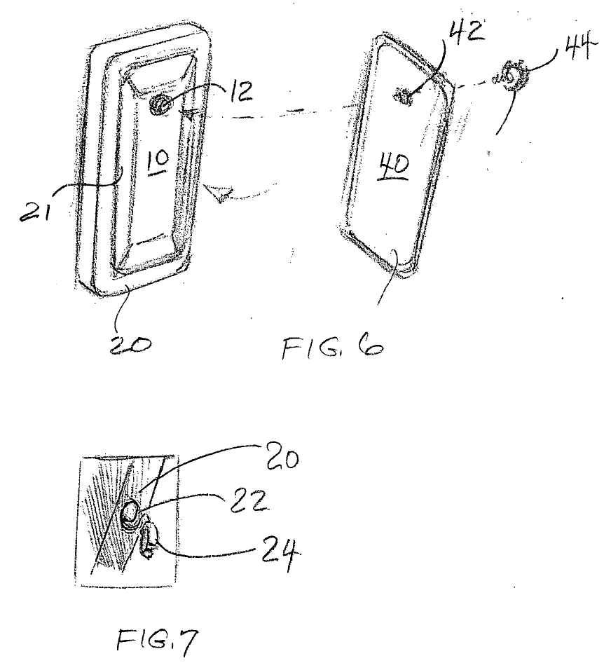

The outer shell 20 is a flexible, water-resistant shell with an open back, best seen in FIG. 2. Edges 21 on a rear face of the outer shell 20 fold over portions of the back face 10B of the inner case 10, as best seen in FIG. 6. Also provided in the outer shell 20 is an earphone-jack aperture 22, fitted with a plastic stopper 24, shown in FIG. 7.

FIG. 4 illustrates the earphone-jack converter 30, which has a connector pin 32 for connecting to the device D. An earphone plug receptacle 34 is provided in the earphone-jack converter 30, for receiving an earphone jack J that typically connects to the device D for providing audio to earphones. An earphone connector pin Jₚ of the jack J is shown in dashed lines, as is circuitry C for functionally connecting the earphone connector pin JPO to the connector pin 32.

FIG. 5 illustrates the inner case 10 with the earphone-jack converter 30 attached to it, and with the conventional earphone jack J plugged into the converter 30. The connector pin 32 on the earphone converter 30 is inserted into the conventional earphone connector provided on the bottom of the device D.

FIG. 6 is an exploded drawing, illustrating how the outer back panel 40 is attached to the outer shell 10. As shown, the inner case 10, along with earphone converter 30 (see FIG. 1) is already inserted into the outer shell 20 and the edges 21 of the outer shell have been folded over the back face of the inner case 10. The outer back panel 40 may now be brought up against the edges 21 and the back face 10B and fastened in place with an attachment means 44. In the embodiment shown, the attachment means 44 is a threaded post that is insertable through an aperture 42 on the outer back panel 40 and threadable into the attachment means 12 provided on the back face 10B of the inner case 10.

FIG. 7 is a close-up of the earphone-jack aperture 22 with the seal means 24, which, in the embodiment shown, is a soft plastic stopper that is adapted to adjustably encircle an earphone cable. The seal means 24 with cable is pushed into the aperture 22, encircling the cable in a manner that provides a water-tight seal.

It is understood that the embodiments described herein are merely illustrative of the present invention. Variations in the construction of the water-resistant case may be contemplated by one skilled in the art without limiting the intended scope of the invention herein disclosed and as defined by the following claims.

What is claimed is:

1. Case for protecting an electronic device, said case comprising:
an inner case with a back face,
an outer shell with an open back, and
an outer back panel,
wherein said electronic device is insertable into said inner case, said inner case is insertable into said outer shell, and said outer back panel is attachable to said back face of said inner case, thereby forming a water-resistant seal between said inner case and said outer shell.

2. The case of claim 1, wherein said inner case further has a front face with apertures for enabling operation of said electronic device and has an open bottom face for receiving said electronic device.

3. The case of claim 2, wherein said inner case is constructed of a form-rigid material.

4. The case of claim 1, said outer shell further comprising an earphone-jack aperture for receiving an earphone jack of said electronic device.

5. The case of claim 4, wherein said earphone-jack aperture includes a seal means for providing a water-resistant seal between said outer shell and said earphone jack.

6. The case of claim 5, wherein said seal means is a flexible plastic material that forms itself sealingly surround said earphone jack.

7. The case of claim 1, wherein said outer shell is constructed of a flexible water-resistant material.

8. The case of claim 7, wherein said material is a silicon material.

9. The case of claim 7, wherein said outer shell has a foldable edge that is foldable over said inner case and is openable for inserting or removing said inner case from said outer shell.

10. The case of claim 1 further comprising an attachment means for releasably attaching said outer back panel to said inner case so as to form a water-resistant seal between said outer back panel and said outer shell.

11. The case of claim 10, wherein said attachment means includes a threaded post and a threaded aperture for receiving said threaded post.

12. The case of claim 1 further comprising an earphone-jack converter having a connector post for connecting to an earphone-jack connector on said electronic device, a connector plug receptacle for receiving an earphone jack, and circuitry for electronically connecting said earphone jack to said connector post.

13. The case of claim 12, wherein said earphone-jack converter is connectable to said electronic device that is encased within said inner case, and wherein said inner case, with said electronic device and said earphone-jack converter, is insertable in said outer shell.

14. The case of claim 13, wherein earphone-jack aperture in said outer shell and said earphone-jack converter, when connected to said electronic device in said inner case, are configured to receive a connector pin of said earphone jack in an orientation that is orthogonal to an orientation of a connector pin of an earphone jack that is conventionally inserted into said electronic device.
